(19) United States
(12) Patent Application Publication
(10) Pub. No.: US 2024/0177051 A1
(43) Pub. Date: May 30, 2024

(54) ADJUSTMENT OF TRAINING DATA SETS FOR FAIRNESS-AWARE ARTIFICIAL INTELLIGENCE MODELS

(71) Applicant: PAYPAL, INC., San Jose, CA (US)

(72) Inventors: Roy Lothan, Tel Aviv (IL); Itay Margolin, Pardesiya (IL); Matan Marudi, Or Yehuda (IL); Yarden Raiskin, Petaáº-Tiqwa (IL)

(21) Appl. No.: 18/059,277

(22) Filed: Nov. 28, 2022

(51) Int. Cl. G06N 20/00

(52) U.S. Cl. CPC G06N 20/00

(57) ABSTRACT

There are provided systems and methods for adjustment of training data sets for fairness-aware artificial intelligence models. A service provider, such as an electronic transaction processor for digital transactions, may utilize different decision services that implement rules and/or artificial intelligence models for decision-making of data including data in production computing environment. Decision services may be used for data processing and decision-making, where multiple decision services may be invoked during run-time in order to complete a data processing request. When processing data, machine learning and other artificial intelligence models may be utilized by such decision services. These may be trained using a sampled training data set that takes into account data records' diversity and model attribution scores as providing valuable data points or observations for training and/or retraining the ML model. The sampled training data may be analyzed to determine these scores and generated for training.

### TECHNICAL FIELD

The present application generally relates to a machine learning (ML) or other artificial intelligence (AI) training system, and more particularly to generating more diverse and fairness-aware training data sampling for ML model training.

### BACKGROUND

Online service providers may offer various services to end users, merchants, and other entities. This may include providing electronic transaction processing data flows, services, and other computing resources. Further, the service provider may provide and/or facilitate the use of online merchant marketplaces and/or transaction processing between different entities. When providing these computing services, the service provider may utilize decision services, which may correspond to micro-computing services having ML-based and/or other AI (e.g., neural network (NN)) engines, computing nodes, execution paths, and the like to process data requests and loads for different outputs (e.g., authentication, risk or fraud analysis, electronic transaction processing, etc.). On receiving a request, a decision service may execute one or more ML or AI models and/or engines, which may be trained based on a set of training data and extracted features. Well-trained AI models are expected to perform well (e.g., provide accurate predictions) when the data-points are “characteristic”, such as when the inputs to the AI model are well represented in the training data set. In this regard, supervised AI models may behave unpredictably when their inputs are in a portion or data representation (e.g., vectorization of feature data) in a feature space that those models were not trained on and/or provided sufficient data to adequately train, balance, and/or weigh nodes, decisions, neural pathways, relationships, and the like. As such, service providers may desire more balanced and fairness-aware (e.g., less biased and/or more diverse for a selected set of data, records, and/or points) in training data sampling and data sets.

### BRIEF DESCRIPTION OF THE DRAWINGS

FIG. 1 is a block diagram of a networked system suitable for implementing the processes described herein, according to an embodiment;

FIG. 2 is an exemplary system operational diagram of operations to determine a fairness-aware set of training data for training of one or more AI models, according to an embodiment;

FIG. 3A are exemplary graphs of different diversities of data points in a feature space, according to an embodiment;

FIG. 3B is an exemplary graph of model attribution scores for maximum value of observations performed when training an AI model using training data, according to an embodiment;

FIG. 4 is a flowchart of an exemplary process for adjustment of training data sets for fairness-aware artificial intelligence models, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for adjustment of training data sets for fairness-aware artificial intelligence models. Systems suitable for practicing methods of the present disclosure are also provided.

A service provider may provide different computing resources and services to users through different websites, resident applications (e.g., which may reside locally on a computing device), and/or other online platforms. When utilizing the services of a particular service provider, the service provider may provide decision services for implementing rules and intelligent (e.g., machine learning (ML) or other artificial intelligence (AI)-based) decision-making operations with such services. For example, an online transaction processor may provide services associated with electronic transaction processing, including account services, user authentication and verification, digital payments, risk analysis and compliance, and the like. These decision services may use ML and other AI-based models, and may be used to determine if, when, and how a particular service may be provided to users. For example, an ML risk rules model and/or engine may be utilized for a decision service to determine if an indication of fraud is present in a digital transaction and payment, and therefore to determine whether to proceed with processing the transaction or decline the transaction (as well as additional operations, such as request further authentication and/or information for better risk analysis). Decision services typically automate repeatable decisions based on decision modeling capabilities so that computing services may execute and perform operations requested by a user's computing device.

For example, a user may utilize online service providers, such as transaction processors, via their available online and networked digital platforms. The user may make a payment to another user or otherwise transfer funds using the online platforms of the service providers. In this regard, a user may wish to process a transaction, such as for a payment to another user or a transfer. A user may pay for one or more transactions using a digital wallet or other account with an online service provider or transaction processor (e.g., PayPal®). An account may be established by providing account details, such as a login, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information. The account and/or digital wallet may be loaded with funds or funds may otherwise be added to the account or digital wallet. The application or website of the service provider, such as PayPal® or other online payment provider, may provide payments and the other transaction processing services via the account and/or digital wallet.

The online payment provider may provide digital wallet services, which may offer financial services to send, store, and receive money, process financial instruments, and/or provide transaction histories, including tokenization of digital wallet data for transaction processing. The application or website of the service provider, such as PayPal® or other online payment provider, may provide payments and other transaction processing services. In further embodiments, the service provider and/or other service providers may also provide additional computing services, including social networking, microblogging, media sharing, messaging, business and consumer platforms, etc. These computing services may be deployed across multiple different websites and applications for different operating systems and/or device types. Furthermore, these computing services may utilize the aforementioned decision services when determining decisions during data processing. For example, access and use of these accounts may be performed in conjunction with the aforementioned decision services.

The user may utilize the account and/or other computing services provided by the service provider via one or more computing devices, such as a personal computer, tablet computer, mobile smart phone, or the like, and may engage in one or more transactions with a recipient, such as a recipient account or digital wallet that may receive an amount of a payment. When engaging in these interactions, the service provider may utilize the corresponding decision services to process data requests and provide a decision or other output. In this regard, a decision service may include different data processing including those for ML and/or AI models that provide and/or output a response. For example, computing tasks for ML and/or AI models may correspond to executable code, operations, and/or models that may include a client device request processor, a compute for business rules, a data loader, a validation of a data load of the data processing request, a user authenticator, or a response builder for a decision by the decision service, although other tasks may also be used. In this regard, a decision service may include computing tasks that obtain an intended result based on a provided data load for a data processing request. A decision may be output by a decision service based on the responses to each task being executed for the corresponding decision.

These computing tasks may be executed in an order and/or processing flow according to a directed acyclic graph (DAG) or another directed graph or ordering of the computing tasks for execution by the decision service. For example, a DAG or other graph may correspond to a flow between computing tasks that causes output of a decision. Computing tasks may be arranged in an order within a DAG depending on the decision service and/or data processing request, for example, so that certain computing tasks may execute and provide data for processing by later computing tasks. A data processing request may be a request from a client computing device, such as an end user or customer of the service provider system, which may request use of a computing service and provide a data load for processing. For example, a data processing request may be associated with a particular request for use of a service for account login, authentication, electronic transaction processing, risk or fraud, and other ones of the aforementioned computing services. The directed graph may therefore correspond to the execution flow and show the different execution paths for executing the computing tasks or the like. This graph may be used for the execution of one or more ML or other AI models for decision-making by such decision service(s).

In some environments and/or conditions, machine learning models may become biased and/or trained with biased data sets, such as those that favor a certain group of data and/or data points that may be more common and/or aligned in training data sets. For example, a training data set may have a larger portion, percentage, and/or number of data points that are the same or similar, which may affect ML and other AI model training. As such, a control group for training data may be generated to evaluate solutions by creating an unbiased group that acts as a baseline for AI model training. This may optimize the assets and other data used for the control group of online models in order to maximize cach sample contribution while minimizing the expected loss during data sampling. In this regard, this may be done by determining candidate data points and/or other data records and determining how diverse each candidate is, how much and/or the cost to utilizing the data, and how informative the data is to the model when training and/or retrained. This may utilize loss function components to domain problems and issues with training data sets.

A training data set may be accessed and utilized for training a ML or other AI model based on a set of features selected for the model an output classification, decision, score, or the like to be provided by the model. The training data may then be sampled in order to provide a sampled and/or fairness aware set of training data that seeks to adjust, minimize, and/or eliminate bias in the training data set. This may be done using two components for a diversity score, such as how diverse a data point or record is from the rest of the grouping and/or set of data records, and a model attribution score of the data point or record that indicates how informative the record is for training a next or updated version of the mode. The sampling scoring method may be generalized and may be plugged into and/or utilized with different models, use cases, and/or training algorithms and paradigms.

For example, the diversity score may quantify and/or describe the incremental knowledge obtained by the ML model when sampling a new observation during ML model training. For example, observations (e.g., data points, data records, vectorization of data fields, etc.) in previously unexplored regimes, feature spaces, vectorizations, and the like, such as when plotted in a feature space, may yield higher diversity scores than those having the same or similar to other observations and/or data points/records. Thus, given a set of observations in a feature space, the sampling may choose additional observations that are distant from one another and thus, diverse from those observations. An additional observation that is nearby existing observations in feature space may be likely to provide less incremental information compared to an observation that is further away, and therefore lead to model bias, inefficient model training, or the like. This may be done by estimating the distribution over the feature space of all the points, records, or the like in the dataset (i.e., training set), for example, using density estimation techniques (e.g., Kernel Density, Gaussian Mixture models, etc.). Thereafter, for each record in the dataset, a diversity score may be determined by calculating the inverse of the record or other data's density estimate within the dataset. Thus, the diversity score may represent how diverse an observation is from the rest of the dataset.

A model attribution score may describe a level of confidence relating to the model scores and/or outputs that may be provided for a data processing transaction or other requested decision-making. For example, with regard to electronic transaction processing, a model may be significantly certain that a transaction is fraudulent if its score at or near an output of 1, and therefore conversely may provide an output that a transaction is safe if at or near 0. However, when the model provides an output around 0.5 or in the middle between the two most certain output scores, decisions, or predictions, the model may be uncertain regarding the outcome of a transaction as being fraudulent or safe. Thus, samples and data records may be prioritized in the dataset that the current model does not perform well on for future learning. The entropy of the score can be as a metric to define the value of each observation may be used. In this regard, the entropy may be measured between the score extremes (e.g., 0 and 1), where a maximum entropy score may be at or near 0.5 for maximum entropy and model attribution.

Thereafter, the scores may be combined and/or weighted in order to determine the value and/or usage of each data record, point, or other observation in the training data set. This may then be used to generate a sampled training data set. One or more ML or other AI models may be then trained using such training data. These fairness-aware or unbiased models therefore provide better decision-making and predictive outputs by weighing many diverse and distributed data points, for example, by preventing mistakenly allocating outputs when overly training on the same or similar data. This may lead to a more diverse representation in the training data set, reducing errors due to bias and lack of representation. Thus, ML and other AI models may be better trained to provide improved and efficient models.

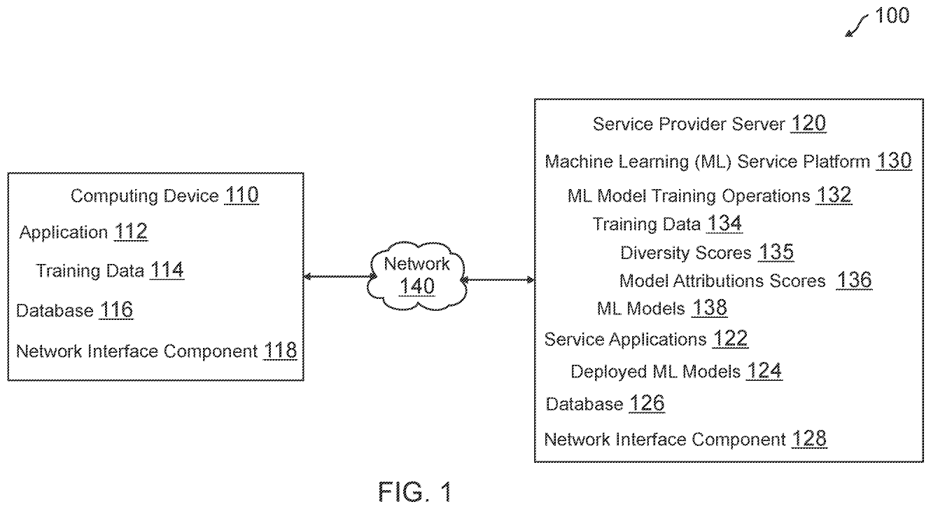

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entity.

System 100 includes a computing device 110 and a service provider server 120 in communication over a network 140. Computing device 110 may be utilized by a user to access a computing service or resource provided by service provider server 120, where service provider server 120 may provide various data, operations, and other functions to computing device 110 via network 140. These computing services may utilize decision services for decision-making during data processing. In this regard, computing device 110 may be used to access a website, application, or other platform that provides computing services. Service provider server 120 may provide computing services that process data and provide ML and other AI decisions in response to data processing requests based on ML or AI models trained using a sampled training data set that is fairness aware.

Computing device 110 and service provider server 120 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 140.

Computing device 110 may be implemented as a communication device that may utilize appropriate hardware and software configured for wired and/or wireless communication with service provider server 120. For example, in one embodiment, computing device 110 may be implemented as a personal computer (PC), a smart phone, laptop/tablet computer, wristwatch with appropriate computer hardware resources, eyeglasses with appropriate computer hardware (e.g., GOOGLE GLASS® and/or other headsets including metaverse configured headsets), other type of wearable computing device, implantable communication devices, and/or other types of computing devices capable of transmitting and/or receiving data. Although only one device is shown, a plurality of devices may function similarly and/or be connected to provide the functionalities described herein.

Computing device 110 of FIG. 1 contains an application 112, a database 116, and a network interface component 118. Application 112 may correspond to executable processes, procedures, and/or applications with associated hardware. In other embodiments, computing device 110 may include additional or different modules having specialized hardware and/or software as required.

Application 112 may correspond to one or more processes to execute software modules and associated components of computing device 110 to provide features, services, and other operations for a user over network 140, which may include accessing and utilizing computing services provided by service provider server 120. In this regard, application 112 may correspond to specialized software utilized by a user of computing device 110 that may be used to access a website or application (e.g., mobile application, rich Internet application, or resident software application) that may display one or more user interfaces that allow for interaction with the computing services of service provider server 120. In various embodiments, application 112 may correspond to a general browser application configured to retrieve, present, and communicate information over the Internet (e.g., utilize resources on the World Wide Web) or a private network. For example, application 112 may provide a web browser, which may send and receive information over network 140, including retrieving website information, presenting the website information to the user, and/or communicating information to the website. However, in other embodiments, application 112 may include a dedicated application of service provider server 120 or other entity.

Application 112 may be associated with account information, user financial information, and/or transaction histories. However, in further embodiments, different services may be provided via application 112, including social networking, media posting or sharing, microblogging, data browsing and searching, online shopping, and other services available through service provider server 120. Thus, application 112 may also correspond to different service applications and the like. When utilizing application 112 with service provider server 120, application 112 may provide and/or request processing of training data 114, such as during training of one or more ML models by service provider server 120. Training data 114 may correspond to account login, authentication, electronic transaction processing, and/or data for other services described herein, which may include features, data for features, data tables and/or records, data points, vectorized data, and the like that may be used during ML and other AI model training. Training data 114 may have a corresponding data load that is processed via one or more ML or AI trainers and/or models for decision services of service provider server 120 that provide a resulting output and result. As such, application 112 may be used to provide training data that may be processed and sampled in order to provide more fairness-aware training data sets.

In various embodiments, computing device 110 includes other applications as may be desired in particular embodiments to provide features to computing device 110. For example, the other applications may include security applications for implementing client-side security features, programmatic client applications for interfacing with appropriate application programming interfaces (APIs) over network 140, or other types of applications. The other applications may also include email, texting, voice and IM applications that allow a user to send and receive emails, calls, texts, and other notifications through network 140. In various embodiments, the other applications may include financial applications, such as banking applications. Other applications may include social networking applications, media viewing, and/or merchant applications.

The other applications may also include other location detection applications, which may be used to determine a location for the user, such as a mapping, compass, and/or GPS application, which can include a specialized GPS receiver that determines location information for computing device 110. The other applications may include device interface applications and other display modules that may receive input from the user and/or output information to the user. For example, the other applications may contain software programs, executable by a processor, including a graphical user interface (GUI) configured to provide an interface to the user. The other applications may therefore use devices of computing device 110, such as display devices capable of displaying information to users and other output devices, including speakers.

Computing device 110 may further include database 116 stored on a transitory and/or non-transitory memory of computing device 110, which may store various applications and data and be utilized during execution of various modules of computing device 110. Database 116 may include, for example, identifiers such as operating system registry entries, cookies associated with application 112 and/or the other applications, identifiers associated with hardware of computing device 110, or other appropriate identifiers, such as identifiers used for payment/user/device authentication or identification, which may be communicated as identifying the user/computing device 110 to service provider server 120. Moreover, database 116 may include data used for storage and/or provision of training data 114 for service provider server 120.

Computing device 110 includes at least one network interface component 118 adapted to communicate with service provider server 120 and/or other devices and servers over network 140. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Service provider server 120 may be maintained, for example, by an online service provider, which may provide computing services that utilize ML and/or other AI-based engines, services, and/or models to provide responses, output, and/or results to computing device 110 based on data processing requests. In this regard, service provider server 120 includes one or more processing applications which may be configured to interact with computing device 110. For example, service provider server 120 may deploy decision services that include intelligent execution managers in order to determine whether to store a data load utilized by multiple decision services during processing of the data processing requests. In one example, service provider server 120 may be provided by PAYPAL®, Inc. of San Jose, CA, USA. However, in other embodiments, service provider server 120 may be maintained by or include another type of service provider.

Service provider server 120 of FIG. 1 includes a machine learning (ML) service platform 130, service applications 122, a database 126, and a network interface component 128. ML service platform 130 may correspond to executable processes, procedures, and/or applications with associated hardware. In other embodiments, service provider server 120 may include additional or different modules having specialized hardware and/or software as required.

ML service platform 130 may correspond to one or more processes to execute modules and associated specialized hardware of service provider server 120 to provide computing services for account usage, digital electronic communications, electronic transaction processing, and the like. In this regard, ML service platform 130 may correspond to specialized hardware and/or software used by a user associated with computing device 110 to utilize one or more computing services through service applications 122, which in turn utilize decision services and/or other computing applications and platforms corresponding to computing microservices for decision-making during runtime through ML and other AI-based models and/or engines. Service applications 122 may include and/or utilize various applications, such as those that may correspond to electronic transaction processing, payment accounts, payment messaging, and the like, as well as other computing operations as further discussed herein. For example, service applications 122 may include social networking, media posting or sharing, microblogging, data browsing and searching, online shopping, and other services available through service provider server 120. Service applications 122 may be used by a user to establish an account and/or digital wallet, which may be accessible through one or more user interfaces, as well as view data and otherwise interact with the computing services of service provider server 120. In various embodiments, financial information may be stored to the account, such as account/card numbers and information. A digital token or other account for the account/wallet may be used to send and process payments, for example, through an interface provided by service provider server 120. The payment account may be accessed and/or used through a browser application and/or dedicated payment application, which may provide user interfaces for access and use of the computing services of ML service platform 130.

The computing services may be accessed and/or used through a browser application and/or dedicated payment application executed by computing device 110, such as application 112 that displays UIs from service provider server 120 for ML service platform 130. Such account services, account setup, authentication, electronic transaction processing, and other computing services of service applications 122 for ML service platform 130 may utilize decision services and/or other computing services that utilize ML models and/or engines, such as for authentication, electronic transaction processing, risk analysis, fraud detection, and the other decision-making and data processing required by the aforementioned computing services. Various computing tasks that employ ML and other AI models and engines for decision-making may be trained using all or a portion of training data 114, such as through ML model training operations 132.

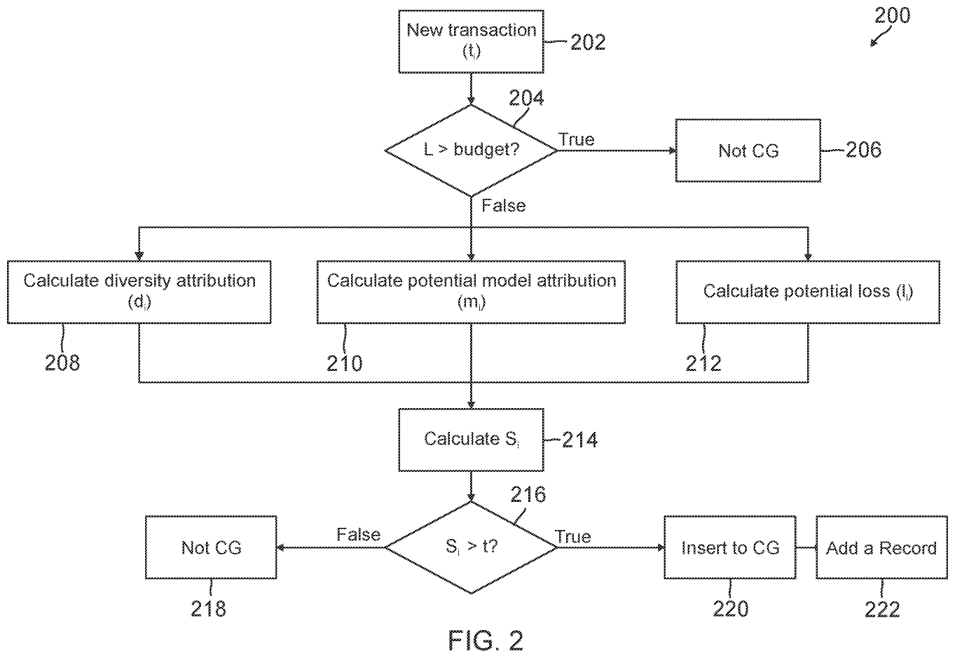

In this regard, ML model training operations 132 may process training data 134 that may include training data 114 from computing device 110 and/or other available training data records, data points, and/or observations (e.g., quantifications and vectorizations based on ML features and other data from data records and the like). Training data 134 may be processed using operations for sampling and selection of a fairness-aware set of data records used to train one or more of ML models 138. In this regard, training data 134 may be processed to determine diversity scores 135 and model attribution scores 136 for different data points, records, and the like in training data 134, which may be used to build a set of sampled and better fairness-aware set of training data that allows for unbiased and/or more distributed or fair set of training data. Diversity scores 135 may be determined based on a diversity of data records from other ones of the data records, with those being more diverse favored of un-diverse records. Model attribution scores 136 may be determined based on an affect or confidence a data record has in resulting in a correct or accurate prediction, with those having less confidence being favored for training to increase model accuracy. The operations to determine diversity scores 135 and model attribution scores 136 are discussed in further detail with regard to FIGS. 2-4. Thereafter, training data 134 may be sampled and used for training of ML models 138.

In this regard, decision services may train and utilize ML models 138 to interact with and process data from service applications 122, such as to determine, based on training from training data 134, a predictive output, decision, score, or other result for a computing process by a decision service, application, or the like. In some embodiments, ML models 138 may include AI models, such as ML or neural network (NN) models. AI models may generally correspond to any artificial intelligence that performs decision-making based on a set of training data. However, AI models may also include subcategories, including ML models and NN models that instead provide intelligent decision-making using algorithmic relationships. Generally, NN models may include deep learning models and the like, and may correspond to a subset of ML models that attempt to mimic human thinking by utilizing an assortment of different algorithms to model data through different graphs of neurons, where neurons include nodes of data representations based on the algorithms that may be interconnected with different nodes. ML models may similarly utilize one or more of these mathematical models, and similarly generate layers and connected nodes between layers in a similar manner to neurons of NN models.

When building ML models 138, training data 134 and/or a sampled set of training data 134 may be used to generate one or more classifiers and provide recommendations, predictions, or other outputs based on those classifications and an ML model. The training data may be used to determine input features for training predictive scores or other outputs. For example, ML models 138 may include one or more layers, including an input layer, a hidden layer, and an output layer having one or more nodes, however, different layers may also be utilized. For example, as many hidden layers as necessary or appropriate may be utilized. Each node within a layer is connected to a node within an adjacent layer, where a set of input values may be used to generate one or more output scores or classifications. Within the input layer, each node may correspond to a distinct attribute or input data type that is used to train ML models 138.

Thereafter, the hidden layer may be trained with these attributes and corresponding weights using an ML algorithm, computation, and/or technique. For example, each of the nodes in the hidden layer generates a representation, which may include a mathematical ML computation (or algorithm) that produces a value based on the input values of the input nodes. The ML algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node to produce one or more output values for the ML models 138 that attempt to classify input data for features and/or score such data. Thus, when ML models 138 are used to perform a predictive analysis and output, the input may provide a corresponding output based on the classifications trained ML models 138.

ML models 138 may be trained by using training data associated, as well as the aforementioned features for the models. By providing training data 134 and/or a sampled set of training data 134 to train ML models 138, the nodes in the hidden layer may be trained (adjusted) such that an optimal output (e.g., a classification) is produced in the output layer based on the training data. By continuously providing different sets of training data and penalizing ML models 138 when the output of ML models 138 is incorrect, ML models 138 (and specifically, the representations of the nodes in the hidden layer) may be trained (adjusted) to improve its performance in data classification. Adjusting ML models 138 may include adjusting the weights associated with each node in the hidden layer. Thus, the training data may be used as input/output data sets that allow for ML models 138 to make classifications based on input attributes.

Service applications 122 may correspond to one or more processes to execute modules and associated specialized hardware of service provider server 120 to process a transaction or provide another service to customers, merchants, and/or other end users and entities of service provider server 120. In this regard, service applications 122 may correspond to specialized hardware and/or software used by service provider server 120 to providing computing services to users, which may include electronic transaction processing and/or other computing services using accounts provided by service provider server 120. In some embodiments, service applications 122 may be used by users associated with client devices 110 to establish user and/or payment accounts, as well as digital wallets, which may be used to process transactions. In various embodiments, financial information may be stored with the accounts, such as account/card numbers and information that may enable payments, transfers, withdrawals, and/or deposits of funds. Digital tokens for the accounts/wallets may be used to send and process payments, for example, through one or more interfaces provided by service provider server 120. The digital accounts may be accessed and/or used through one or more instances of a web browser application and/or dedicated software application executed by client devices 110 and engage in computing services provided by service applications 122. Computing services of service applications 122 may also or instead correspond to messaging, social networking, media posting or sharing, microblogging, data browsing and searching, online shopping, and other services available through service provider server 120. Such computing services may utilize deployed ML models 124 for ML or other AI decision-making, scoring, and/or outputs.

In various embodiments, service applications 122 may be desired in particular embodiments to provide features to service provider server 120 through deployed ML models 124. For example, service applications 122 may include security applications for implementing server-side security features, programmatic client applications for interfacing with appropriate application programming interfaces (APIs) over network 140, or other types of applications. Service applications 122 may contain software programs, executable by a processor, including a graphical user interface (GUI), configured to provide an interface to the user when accessing service provider server 120 via one or more of client devices 110, where the user or other users may interact with the GUI to view and communicate information more easily. In various embodiments, service applications 122 may include additional connection and/or communication applications, which may be utilized to communicate information to over network 140.

Additionally, service provider server 120 includes database 126. Database 126 may store various identifiers associated with computing device 110. Database 126 may also store account data, including payment instruments and authentication credentials, as well as transaction processing histories and data for processed transactions. Database 126 may store financial information and tokenization data. Database 126 may further store data associated with training data 134, such as diversity scores 135, model attribution scores 136, and/or sampled data sets.

In various embodiments, service provider server 120 includes at least one network interface component 128 adapted to communicate computing device 110 and/or other devices and servers over network 140. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 140 may be implemented as a single network or a combination of multiple networks. For example, in various embodiments, network 140 may include the Internet or one or more intranets, landline networks, wireless networks, and/or other appropriate types of networks. Thus, network 140 may correspond to small scale communication networks, such as a private or local area network, or a larger scale network, such as a wide area network or the Internet, accessible by the various components of system 100.

FIG. 2 is an exemplary system operational diagram 200 of operations to determine a fairness-aware set of training data for training of one or more AI models, according to an embodiment. Diagram 200 includes a graph for an execution flow, such as one for a corresponding set of ML or other AI model training discussed in reference to system 100 of FIG. 1. Diagram 200 may correspond to an execution flow of ML model training operations 132 of service provider server 120 that dynamically determines training data sets that are more unbiased and/or diverse in fairness and distribution of data points for improved ML model training.

Diagram 200 shows a data flow corresponding to data and execution flows and/or pathways for generating fairness-aware training data sets. For example, the data flow may correspond to a data processing operation for generation of a sampled training data set for use when training, adjusting, and/or retraining one or more ML models. In this regard, diagram 200 may be used for “smart” or selective generation of a control group of data points that may then be used in order to assess and process other data records, points, and/or observations for determination of inclusion of such data into a sampled training data set. In this regard, diagram 200 may be used to determine how diverse a candidate observation or other data point is from the rest of the grouping of the sampled or full training data, how cheap or easy the data is to process, and how informative the data is for the next version of the model when developed (e.g., how much the data will attribute to the model training and/or scoring). This may allow for sampling of data into a control group used for training data and/or identification of training data records, points, or observations as “fairness-aware” or otherwise providing a less biased set of training data.

With regard to transactions and/or electronic transaction processing, diagram 200 may process a set of training data for such transactions and/or processing. At block 202, a new transaction is received. This may correspond to a data record, data point, or other representation of the data (e.g., a vectorization with n-parameters, features, or characteristics, which may also be mathematically represented). Such a transaction may correspond to one or more entries in a data table that may have a row of data features utilized by the ML model for ML model training and/or processing. In this regard, one or more computation decision services may be based on a computation flow and/or graph, where each of the computation decision services require the same, similar, or different data loads based on requirements for data processing of the request. Each of the computation decision services may have different data computation statistics, requirements, SLAs, and the like that determine a computation time and/or requirement (e.g., resource usage, storage, etc.). SLAs and other requirements may also be utilized, accessed, and/or received from internal and/or external components where applicable. An SLA may indicate the required time to respond to a data processing request negotiated between the client device and the corresponding service provider associated with the decision service. In this regard, the SLA specifies a maximum amount of time negotiated between devices and/or servers for the required level of service that is provided.

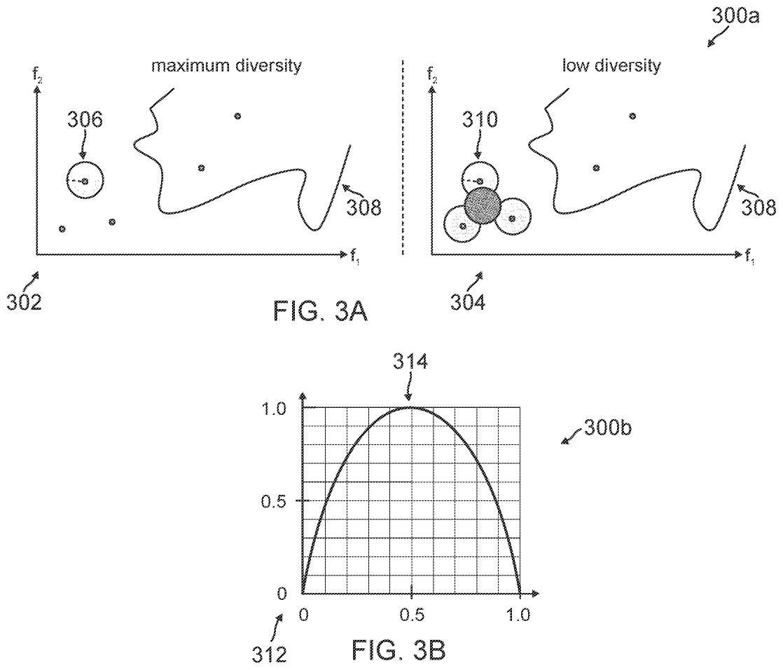

At block 204, it is determined whether the cost is valid versus the budget of the data record or other data point for the transaction. If the cost exceeds the budget, at block 206, the transaction is not added to the control group. This may be based on a transaction's total payment volume (TPV) and/or probability of loss, which may be used to determine whether sampling of the transaction is necessary based on weighted potential loss. However, if false, at blocks 208, 210, and 212, the transaction's data record is processed. In this regard, a diversity attribution or score may be calculated at block 208, such as a determination as to how much a candidate data record may be diverse from other data records in the corresponding data set (e.g., the training data). This may be based on how distant or other measurement of coordinate or vector space between such data records in a feature space. Those observations that are similar or the same may provide incrementally less information, and therefore a weight may be applied to favor or select data points that are more distant and therefore more unrelated or diverse. For example, using a density estimation technique (e.g., Kernel Density, Gaussian Mixture models, etc.), for each record in a dataset, a diversity score may be calculated as the inverse of that record's density estimate within the dataset. Thus, the diversity score may represent how diverse this observation is from the rest of the dataset. Calculation of a diversity score and usage in a plot for a field of data points in a distribution of such diversity, such as over a feature space, is shown in further detail with regard to FIG. 3A.

At block 210, a potential model attribution or score is calculated. This may be done by determining how informative the record is for next versions of the model, such as how confident is the model in processing the data record or other observation. For example, certain ML models and/or other algorithms and ML model trainers may be significantly confident in certain data classifications, while less confident in others. With less confident, or more entropic, predictions, the ML models may learn better and provide more diverse and less biased predictions. Calculation of a model attribution score and modeling of a plot of such attributions to model predictability and/or certainty is shown in further detail with regard to FIG. 3B. Potential loss may also be calculated at block 212, which may include the potential loss due to a fraudulent (or other) transaction based on a classification of the transaction. Such information may be based on incorrectly identifying and/or classifying data, and the potential TPV or other value metric associated with such classification in order to reduce bias and/or errors.

At block 214, a sampling score is determined, which is compared to a threshold at block 216. The sampling score may correspond to a weighted score of the diversity score, model attribution score, and/or potential loss. The threshold may be established by one or more administrators, data scientists, or other users, and may be set to identify those data records or other observations to add to the control group. If not exceeding the threshold, at block 218, the observation is not added to the control group. However, if meeting or exceeding the threshold, then at block 220, the data record, observation, or the like is added to the control group and utilized for model training and/or identification of other data for the sampled training data set. For example, at block 222, a data record may then be added to a training data set, such as one of those utilized based on the data determined using the graphs of FIGS. 3A and 3B.

FIG. 3A are exemplary graphs 300a of different diversities of data points in a feature space, according to an embodiment. FIG. 3B is an exemplary graph 300b of model attribution scores for maximum value of observations performed when training an AI model using training data, according to an embodiment.

Graph 302 of graphs 300a shows diverse data while graph 304 shows non-diverse data in a vector or feature space. The sampling scoring operations and output, Sᵢ for a diversity score (Dᵢ) with a model attribution score (Mᵢ) may be performed using Sᵢ=αDᵢ+βMᵢ, where α, β are the weights for each of the two parameters and are chosen by the needs, business rules, or the like for implementing the scoring algorithm and sampling operations. The distribution score and/or distribution of data points 306, 308, and 310 over the feature space of graphs 302 and 304 for the training data set may be determined using density estimation techniques (e.g., Kernel Density, Gaussian Mixture models, etc.). Then, for each record i in the dataset, the diversity score may be calculated as the inverse of its density estimate within the dataset. Thus, the diversity score may represent how diverse each observation is from the rest of the data set, such that for an

observation i, that score may be given by:

$${D}_{i} = \frac{1}{{P}_{K} ( i )} ,$$

where P_{K}(i) is the likelihood of point i to be observed given the calculated distribution. The distribution may first be estimated over the entire data set and the iterated over each point i in to output diversity scores.

In graph 300b, a parabolic identification of a model attribution score is shown. The model attribution score may describe a level of confidence relating to the model score for a certain output, such as how likely or unlikely a transaction is to be fraudulent. For example, a model can be significantly certain that a transaction is fraudulent if its score=1, or that the transaction is very safe if the score=0. However, when the model score is =0.5, the model may uncertain regarding the outcome of a transaction (fraudulent/safe). When developing a new model and/or retraining a model, samples of data may be prioritized that the current model does not perform well on, which may be important for continued and/or future learning. Thus, an entropy of the score may be used as a metric to define the value of each observation. In this regard, on a model score on observation i as Pᵢ, and the entropy of the score as H(Pᵢ) may be calculated by: H (Pᵢ)=−(Pᵢ log₂ Pᵢ+(1−Pᵢ)log₂(1−Pᵢ)). In this regard, the range of the model attribution score may be between 0 to 1, and the entropy is maximal when the model prediction=0.5. A further loss function by incorrectly classifying data may be implemented. For example, with transactions, the potential loss term may defined as the product of the transaction's TPV and the probability of loss, calculated by the model score, such as by: PLᵢ=pᵢ(loss)·TPV, and therefore an adjusted sampling score may be given by Sᵢ=αDᵢ+βMᵢ−γPLᵢ.

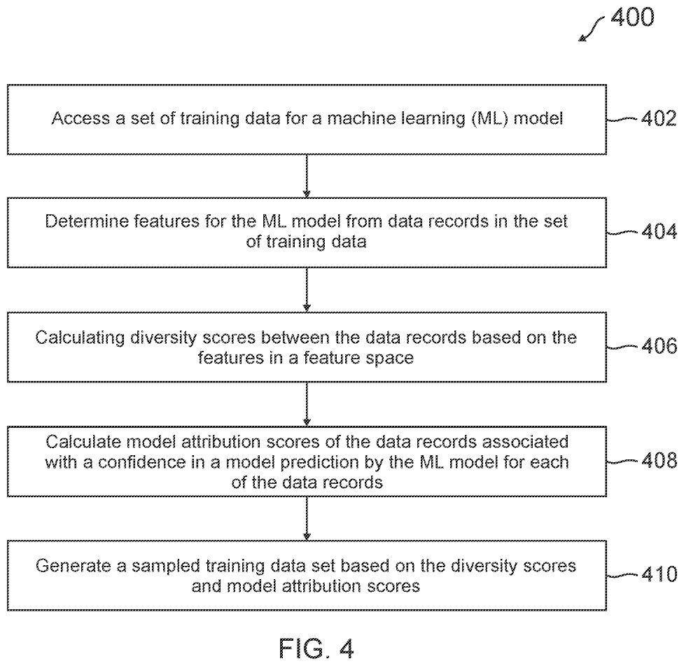

FIG. 4 is a flowchart 400 of an exemplary process for adjustment of training data sets for fairness-aware artificial intelligence models, according to an embodiment. Note that one or more steps, processes, and methods described herein of flowchart 400 may be omitted, performed in a different sequence, or combined as desired or appropriate.

At step 402 of flowchart 400, a set of training data for an ML model is accessed. The training data may be accessed in the event of training, retraining, and/or adjusting one or more ML models for a decision-making service, operation, or application of an online service provider or other computing platform. Such ML model(s) may be used to provide predictive scoring or outputs that are used to classify input data based on a set of features processed by the ML model(s). This training data may be accessed by a ML model trainer that utilizes such data with one or more algorithmic operations to train and generate the ML model(s), as well as adjust and retrain such models. At step 404, features for the ML model from data records in the set of training data are determined. The features may correspond to an input set of data from data records or data points, such as specific columns of the same or similar recorded data in a data record (e.g., a column for multiple rows of data records that may correspond to transaction total, transaction time, transaction location, etc., for processing electronic transactions). The features may be selected and/or established for the ML model(s).

At step 406, diversity scores between the data records are calculated based on the features in a feature space. In this regard, observations or other data records or points may be selected in order to choose such observations that are more diverse from each other, and therefore reside in a feature space for the features that are further apart and not within a neighborhood or other similar area of the feature space. The feature space may correspond to a two-dimensional, three-dimensional, or other vector space used to assign points and/or vectors to different data records, which allows plotting and/or identification of the diversity of such observations from other ones of the observations. For example, with points given in a vector space, points that are distant from one another may be chosen, such as by defining a distance between each point and denoting the neighborhood of the points. Thereafter, this distance may be used to define the incremental knowledge of the point from other points and determine whether such distance meets or exceeds a threshold. Thus, data in the control group and/or training data set may be used to calculate a distribution of points in the feature space, which may be used to determine new candidate observations diversity and whether such candidates may be selected for the sampled training data.

At step 408, model attribution scores of the data records that are associated with a confidence in a model prediction by the ML model for each of the data records are calculated. A model attribution score may be associated with an observation's entropy in the model scoring or output for that observation. For example, an ML model may be significantly certain of the output of certain input data records and/or feature data, such as defining an electronic transaction as fraudulent or safe. However, the ML model may also be less certain of other observations, such as if a transaction is not sure to be either fraudulent or safe (e.g., defined in a middle territory, score, or output by the ML model). Those observations that are certain may be of less value in the training data set, and therefore, the training data may be sampled to select observations where the current model and/or training is more uncertain. An entropy of the model attribution score may therefore correspond to this uncertainty, where more uncertainty may more highly weigh the corresponding data observation for use in model training and future learning. At step 410, a sampled training data set is generated based on the diversity scores and the model attribution scores. This may then be used to train the ML or other AI model for decision-making based on a sampled training data set. Thus, a ML model may be trained and then utilized to receive a transaction request or the like, and then thereafter access and utilized to perform an analysis of the transaction request and/or transaction data. This may be done for risk, fraud, compliance, money laundering detection, or the like to ensure transaction validity or fraud. Such analysis may be performed based on an out of the ML model trained using the fairness-aware data and may provide a more biased and/or accurate data output.

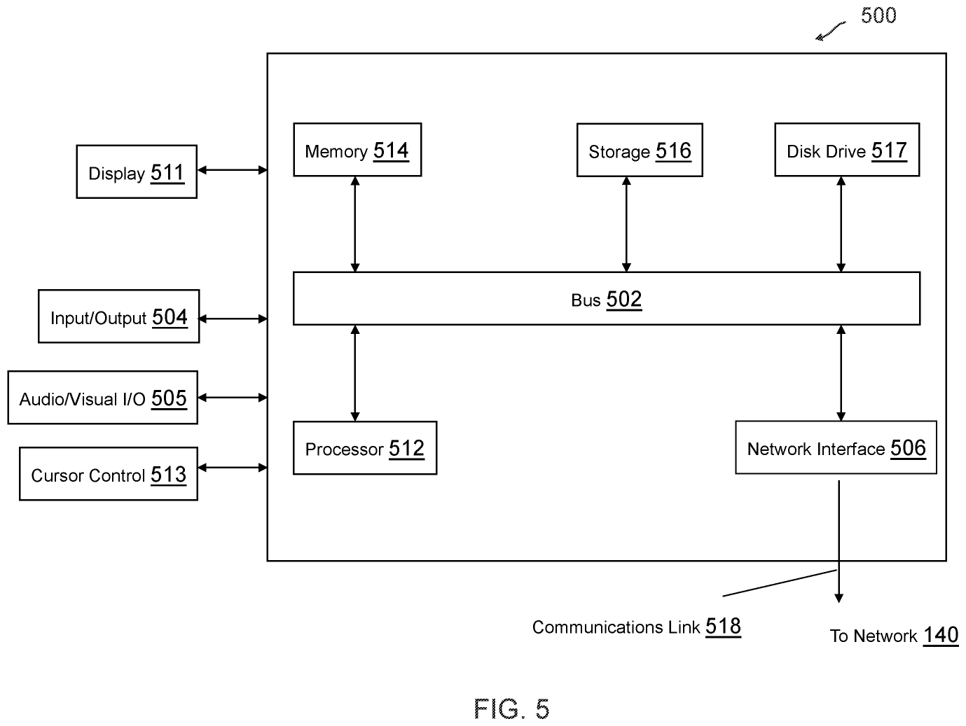

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 140. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to read instructions from the non-transitory memory to cause the system to perform operations comprising:
receiving training data for a machine learning (ML) model comprising a plurality of data records;
calculating, for each of the plurality of data records, a diversity score of each of the plurality of data records based on a distribution of each of the plurality of data records in a feature space associated with the ML model;
calculating, for each of the plurality of data records, a model attribution score of each of the plurality of data records associated with outputs of the ML model;
sampling, based on the diversity scores and the model attribution scores, the plurality of data records from the training data; and
generating, based on the sampling, a sampled training data set that enables the ML model to be trained.

2. The system of claim 1, wherein the calculating the diversity score for each of the plurality of data records is based on the distribution is based on a vector distance between different ones of the plurality data records in the feature space from data features utilized by the ML model with the training data.

3. The system of claim 2, wherein the feature space comprises a coordinate placement of each of the plurality of data records in the feature space based on feature data associated with the ML model for each of the plurality of data records, and wherein the diversity score is increased when the vector distance between the different ones of the plurality of data records is increased.

4. The system of claim 3, wherein the coordinate placement is determined based on one of a kernel density, a gaussian mixture, or a clustering algorithm.

5. The system of claim 1, wherein the calculating the model attribution score is based on a level of confidence of an accuracy of each of the outputs associated with each of the plurality of data records by the ML model.

6. The system of claim 1, wherein the operations further comprise:
training the ML model using the sampled training data set.

7. The system of claim 1, wherein the operations further comprise:
retraining the ML model from a previous ML model configuration using the sampled training data set.

8. The system of claim 1, wherein the operations further comprise:
determining a first weight to apply to the diversity score and a second weight to apply to the model attribution score; and
applying the first weight to the diversity score and the second weight the model attribution score prior to the sampling.

9. The system of claim 1, wherein the sampled training data set enables the ML model to determine one of a policy selection determination, a risk and fraud analysis, or a marketing model.

10. A method comprising:
accessing, for each of a plurality of data records, diversity scores and model attribution scores for the plurality of data records, wherein the diversity scores are associated with distributions of the plurality of data records in a feature space, and wherein the model attribution scores are associated with confidences in an output of a machine learning (ML) model for the plurality of data records;
calculating a sampling score for each of the plurality of data records based on the diversity scores and the model attribution scores;
generating a sampled training data set for the ML model based on the calculated sampling scores; and
training the ML model based on the sampled training data set.

11. The method of claim 10, wherein prior to the accessing, the method further comprises:
estimating the distributions of the plurality of data records over the feature space for features associated with the plurality of data records; and
determining the diversity scores based on the estimating.

12. The method of claim 11, wherein the estimating the distributions comprises determining distances between the distributions in the feature space.

13. The method of claim 11, wherein prior to the accessing, the method further comprises:
calculating a likelihood of one of the plurality of data records to be observed during training of the ML model based on the distributions,
wherein the diversity scores are further based on the calculated likelihood.

14. The method of claim 13, further comprising:
iterating the calculating of the likelihood over the plurality of data records using the distributions.

15. The method of claim 10, wherein prior to the accessing, the method further comprises:
calculating the confidences in the output of the ML model for the plurality of data records based on certainties that the plurality of data records are correctly classified by the ML model.

16. The method of claim 15, wherein the calculating the confidences is performed using a previous iteration of the ML model.

17. A non-transitory machine-readable medium having stored thereon machine-readable instructions executable to cause a machine to perform operations comprising:
identifying a machine learning (ML) model utilized by a computing service of a service provider system;
accessing, for a plurality of data records, diversity scores and model attribution scores for the plurality of data records, wherein the diversity scores are associated with distributions of the plurality of data records, and wherein the model attribution scores are associated with confidences in an output of the ML model for the plurality of data records;
determining a weight to assign to each of the diversity scores and a weight to assign to each of the model attribution scores based on the ML model;
calculating a sampling score for each of the plurality of data records based on the diversity scores, the model attribution scores, and the weights;
generating a sampled training data set for the ML model based on the calculated sampling scores; and
retraining the ML model based on the sampled training data set.

18. The non-transitory machine-readable medium of claim 17, wherein the ML model is previously trained using a set of sampled data from at least a portion of the plurality of data records.

19. The non-transitory machine-readable medium of claim 17, wherein the retraining comprises reconfiguring at least one of a weight or a value of one or more nodes of the ML model based on the sampled training data set.

20. The non-transitory machine-readable medium of claim 17, wherein the diversity scores are based on a distribution in a feature space of the plurality of data records, and wherein and the model attribution scores are based on a confidence of a predictive output for each of the plurality of data records by the ML model.
